(19) United States
(12) Patent Application Publication
(10) Pub. No.: US 2006/0238753 A1
(43) Pub. Date: Oct. 26, 2006

(54) Visual inspection apparatus

(75) Inventors: Haruyuki Tsuji, Ina-shi (JP); Yoshiaki Suge, Kamiina-gun (JP); Hiroshi Naiki, Ina-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/407,301

(22) Filed: Apr. 19, 2006

(30) Foreign Application Priority Data
Apr. 21, 2005 (JP) P2005-123944

(51) Int. Cl. G01N 21/88

(52) U.S. Cl. 356/237.2

(57) ABSTRACT

A visual inspection apparatus of the present invention comprising illuminating units such as a wide range illuminating unit irradiating light on a wafer, a slit illuminating unit, and a spot illuminating unit, a swinging mechanism that movably swings and retains a wafer, and a control unit that controls these illuminating units and the swinging mechanism. This visual inspection apparatus wherein inspection condition setting values are input by a keyboard, mouse and so on, summarized by inspection process and stored in a storage unit as setting information for inspection processes, which are selected and inspected by a setting information selection unit in the control unit.

### BACKGROUND OF THE INVENTION

1. Field of the Invention

The present invention relates to visual inspection apparatus. For instance, the present invention relates to visual inspection apparatus for inspecting defects that can be detected macroscopically, such as unevenness in film thickness, dirt, pattern scratches, and defocusing on the surface of semiconductor wafer substrates, liquid crystal glass substrates and so on, by irradiating illuminating light on the test object and visually observing its image.

Priority is claimed on Japanese Patent Application No. 2005-123944, filed Apr. 21, 2005, the content of which is incorporated herein by reference.

2. Description of Related Art

Macro inspection devices for de existence of defects, approximate positions, types of defects and so on, from the scattering of light due to scratches, dirt and the like, and disturbances in images by reflected light after substantially illuminating a test object in visual inspection apparatus for semiconductor wafer substrates and liquid crystal glass substrates and so on, are well known since the past. Furthermore, micro inspection devices that perform inspection of defects after acquiring enlarged images of the surface of test objects for detecting localized defects such as defects in wiring pattern based on defect position information from macro inspection devices, are also well known as visual inspection apparatuses.

To acquire diffracted light images due to micro wiring patterns in automatic macro inspection devices that automatically detect defects, means such as illumining means and imaging means are moved relative to each other with high accuracy by moving mechanisms. For this reason, inspection condition setting values such as illumination conditions for illuminating means and imaging positions of the imaging unit are summarized by test object and stored in data files (so-called “recipes”) before inspection. Settings of inspection conditions are performed, and based on these setting conditions, the moving mechanism is automatically driven, and images are acquired by the imaging means. These images are subjected to image processing and automatic inspections are performed to detect defects.

For instance, PCT International Publication No. WO 01/071323 (in FIGS. 1 to 3), describes a defect detection apparatus that comprises a retaining unit that retains a test object, an imaging unit that photographs the test object at specified angle, and a host computer that controls these units and processes data. This apparatus automatically determines conditions considered to be optimum for from graphs and calculations, and stores them in the host computer.

On the other hand, in a visual macro inspection apparatus mainly operated manually, the method of observing a defect varies considerably with the method of illumination used. Since predicting the conditions for detecting defects with good accuracy is difficult, the test object is movably swung in three dimensions and retained by swinging means, and the method of illuminating the object can be freely varied.

The ease of observing a defect differs depending on the visual acuity and the level of skill of the inspector. Therefore, visual macro inspection is generally performed by manually operated the swinging means based on the experience of each inspector, as described in Japanese Unexamined Patent Application, First Publication, No. H09-186209.

Conventional macro inspection apparatuses were operated manually by the swinging means, and inspection setting conditions for illuminating light were set by each inspector. The method of setting the inspection setting conditions depended on the level of skill and individual expertise of each inspector.

If the types of test objects and production processes vary widely, the inspection setting conditions need to be varied accordingly.

On the other hand, automatic inspection after storing the inspection setting conditions (recipes) as in the automatic macro inspection apparatus described in the aforementioned PCT International Publication No. WO 01/1071323 may also be considered, but theoretically predicting the inspection setting conditions that make defects easily visible is difficult in case of visual macro inspection.

In contrast, setting the illuminate conditions and swinging conditions after assigning them a certain range, and varying the inspection conditions within this preset range can be considered. In this case, the inspection setting conditions are decided after assigning them a certain range; therefore, the time for the setting process of inspection seeing conditions can be shortened.

### SUMMARY OF THE INVENTION

The visual inspection apparatus of the preset invention comprises a unit that movably swings and retains a test object, an illuminating unit that irradiates illuminating light on the test object for obey images of the test object, a storage unit that stores setting information for inspection processes for implementing inspection processes, and a cool unit that automatically controls the illuminating unit and/or the swinging unit based on the setting information for inspection processes.

According to this configuration, inspection processes can be implemented by automatic control of the illuminating unit and/or the swinging unit by the control unit, based on the setting information for ins on processes stored in the storage unit; therefore, visual inspection can be performed speedily and efficiently.

Such inspection condition setting values may be set in any arbitrary manner, but setting values based on experience, for instance, actually recorded values of inspection processes performed by experienced inspectors should preferably be used. In this case, even if these values are not optimum inspection condition setting values, the inspector can set optimum inspection condition setting values by operating manually near the inspection condition setting values; therefore, the time required for trial and error process can be cut down.

In the visual inspection apparatus of the present invention, inspection condition setting values can be set collectively beforehand in a control unit based on the setting information for ins on processes stored in a storage unit corresponding to inspection processes. Accordingly, the setting of inspection condition setting values becomes easy. For instance, inspection condition setting values efficiently set by an experienced inspector can be shared and re-used, and visual inspection can be performed speedily and efficiently.

### BRIEF DESCRIPTION OF THE DRAWINGS

FIG. 1 is a perspective view showing the outline configuration of visual inspection apparatus according to an embodiment of the present invention.

FIG. 2 is a control block diagram showing the visual inspection apparatus according to the embodiment of the present invention.

FIG. 3 is a flow chart showing an operation for creating recipes of the visual inspection apparatus according to the embodiment of the present invention.

FIG. 4 is an explanatory sketch for explaining an example of the operation screen when creating a recipe of the visual inspection apparatus according to the embodiment of the present invention.

FIG. 5 is a flow chart showing an operation of the visual inspection apparatus according to the embodiment of the present invention.

FIG. 6 is an explanatory sketch for explaining an example of the operation screen during inspection of the visual inspection apparatus according to the embodiment of the present invention.

FIG. 7 is a graph showing an example of implementation of the Results Display & Analysis mode by the visual inspection apparatus according to the embodiment of the present invention,

FIG. 8 is a graph showing an example of implementation of the Results Display & Analysis mode by the visual inspection apparatus according to the embodiment of the present invention.

### DETAILED DESCRIPTION OF THE INVENTION

The embodiment of the present invention will be explained hereinafter referring to the attached drawings. Even if the embodiment differs, the same reference numeral is assigned to the same or equivalent member, and common explanations are omitted in all the drawings.

The visual inspection apparatus according to the embodiment of the present invention will be described here.

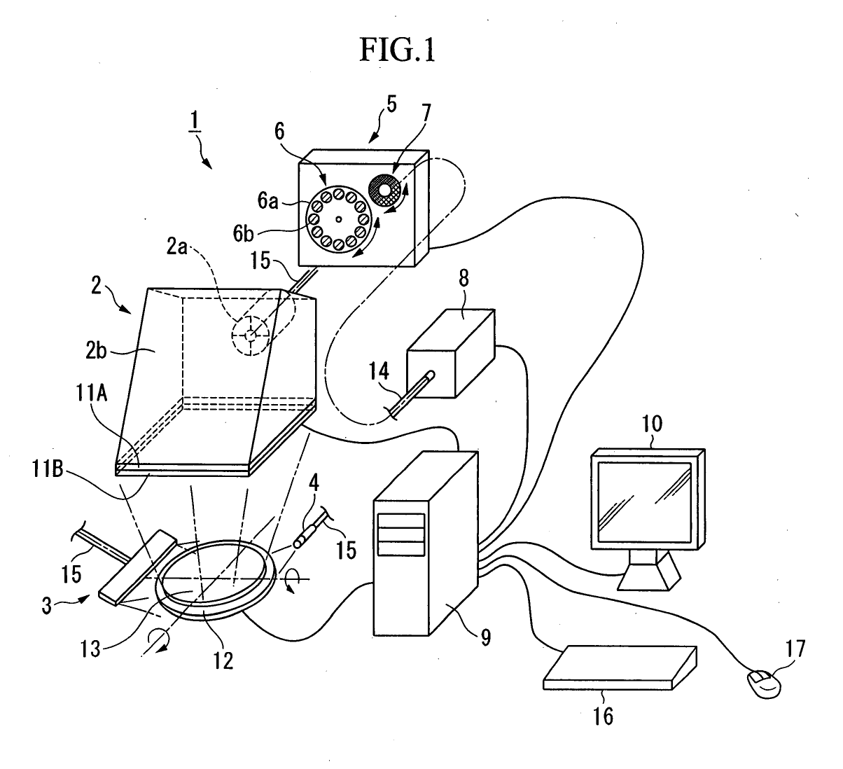

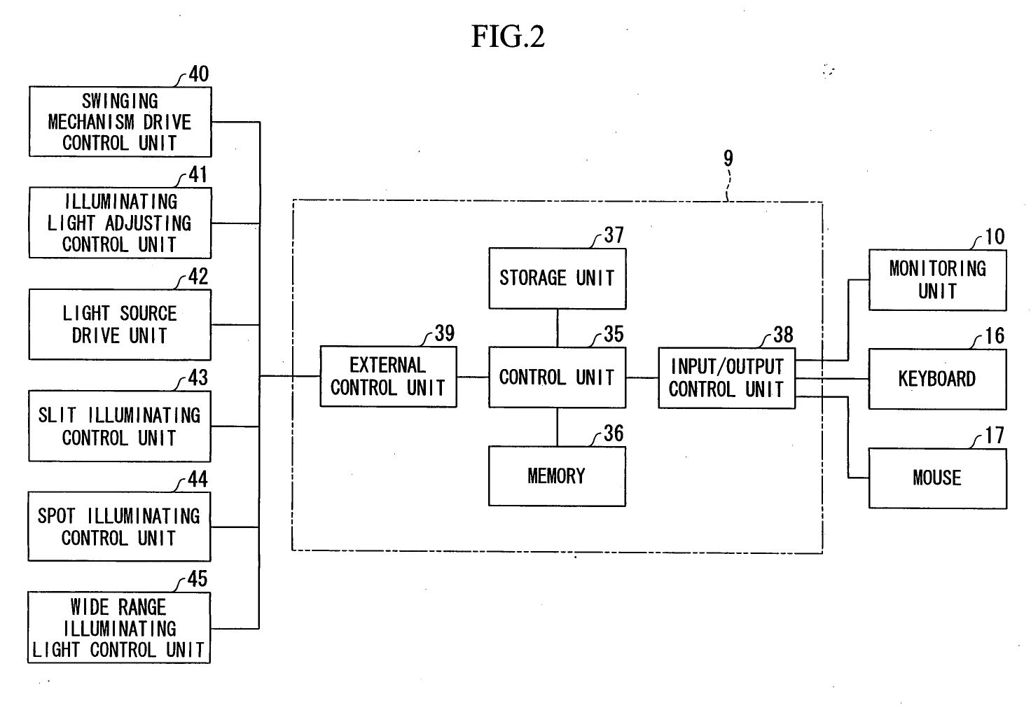

FIG. 1 is a perspective view showing the general configuration of the visual inspection apparatus according to the embodiment of the present invention. FIG. 2 shows the control block diagram of the visual inspection apparatus according to the embodiment of the present invention.

The visual inspection 1 of the present embodiment inspects surface defects in a test object by illuminating the test object and observing the image of the reflected light. As shown in FIG. 1, the apparatus 1 includes a swinging mechanism 12 (swinging unit), a light source 8, an illuminating light adjusting unit 5, a wide range illuminating unit 2 (illuminating mechanism), a slit illuminating unit 3, a spot illuminating unit 4 (illuminating mechanism), a control unit 9, a monitoring unit 10, a keyboard 16 (inspection condition input unit), and a mouse 17 (inspection condition input unit).

The mechanism 12 holds a wafer 13, which is the test object. It is a mechanism that can change the position and attitude of the wafer 13 by appropriate control signals. It further comprises a rotating stage to mount the wafer 13, and a mechanism to rotate the stage around two axes parallel and perpendicular to the plane of the wafer 13. The rating stage holds the wafer 13 by adsorption. Although not shown in the Figs., a movable stage capable of rotating around three axes and having a plurality of motors in three axial directions may be used as the driving source. A swinging mechanism drive control unit 40 (refer to FIG. 2) is also provided that converts the appropriate control signals to drive signals of these driving sources.

The light source 8 comprising a metal halide lamp, halogen lamp and so on, emits substantial white light, is connected to optical fiber 14 so that it can guide the outgoing beam. It can control the switching on and switching off the light through a light source drive unit 42 (refer to FIG. 2).

The illuminating light adjusting unit 5 is a mechanism for emitting light in the adjust condition on to a desired illuminating mechanism after converting appropriately the optical characteristics of light guided by optical fiber 14. A filter wheel 6 and an adjusting light wheel 7 are provided in this embodiment, which can convert the waveform characteristics and can adjust the light intensity through an illuminating light adjusting control unit 41 (see FIG. 2).

The light from the illuminating light adjusting unit 5 is selectively guided to at least one of the following illuminating mechanisms: wide range illuminating unit 2, slit illuminating unit 3 or spot illuminating unit 4, by a plurality of optical fibers 15. This switching operation is also controlled by the illuminating light adjusting control unit 41.

The filter wheel 6 has an optical filter 6b with varying characteristics disposed on the periphery of rotatably installed routing disk 6a by a rotating means (not shown in the Figs.) such as a stepping motor. The configuration is such that a fixed angle rotating means is driven by the illuminating light adjusting control unit 41, and one of the optical filters 6b is selectively moved to the outgoing beam exit of optical fiber 14.

An example of the optical filter 6b is a wavelength selection filter that enables the film unevenness of a test object to be observed easily. To observe film unevenness, a plurality of band pass filters having appropriate wavelength spacing may be used so that the interference due to film unevenness can be easily observed.

The adjusting light wheel 7 is provided with adjustable light bands of varying optical transmittance on the periphery of the rotatably installed rotating disk driven by a rotating means (not shown in the Figs.), such as a stepping motor. The rotating means is driven by the illuminating light adjusting control unit 41 such that the appropriate optical transmittance area is moved to the outgoing beam exit of optical fiber 14.

The adjustable light band may be made of ND filters in which the transmittance varies continuously or discontinuously, but in the present embodiment, it is made of a mesh of variable size.

The wide range illuminating unit 2 is an illuminating mechanism that forms wide range illuminating light irradiated on substantially the entire surface of the wafer 13 from the outgoing light of the optical fiber 15. The wide range illuminating unit 2 comprises an outgoing beam exit 2a that emits light led into it from the optical fiber 15 as diffused light, a reflecting mirror 2b that deflects the outgoing beam from the outgoing beam exit 2a, a Fresnel lens 11A with positive power to concentrate the reflected light of the reflecting mirror 2b to parallel or convergent beams of light, and a liquid crystal scattering plate 11B that converts the light that has passed through the Fresnel lens 11A, if necessary, to a properly scattered condition.

The wafer 13 is disposed on the object side of the focal position of Fresnel lens 11A. The liquid crystal scattering plate 11B can irradiate light on a wide range of areas on the wafer 13, such as the entire surface, half the surface, or one-fourth the surface of the wafer 13, for instance.

The relative position of the outgoing beam exit 2a is variably disposed on the optical axis with respect to the Fresnel lens 11A. As a result, the position of convergence of the outgoing light from the Fresnel lens 11A can also be made infinitely variable. For this reason, depending on the change in the relative position, the light from the wide range illuminating unit 2 can be switched between convergent light and parallel light, and irradiated.

In the present embodiment, the extent of scattering of the liquid crystal scattering plate 11B and the relative positions of the outgoing beam exit 2a and the Fresnel lens 11A can be varied by a wide range illuminating light control unit 45. That is, the wide range illuminating light control unit 45 can vary the light scats characteristics of the liquid crystal scattering plate 11B by varying the voltage driving the liquid crystal scattering plate 11B. More specifically, after switching on the power, if voltage is applied, the plate is made to act as a transparent plate, and the convergent light is irradiated on the substrate and passed through it. Moreover, by switching off the power and cutting off the applied voltage, the plate becomes non-transparent and white light is irradiated on the substrate. Also, for example, the outgoing beam exit 2a can be moved using a motor, not shown in the Figs., and its distance from the Fresnel lens 11A can be varied.

The slit illuminating unit 3 is an illuminating mechanism that converts the light led by the optical fiber 15 through the illuminating light adjusting unit 5, to illuminating light in the form of a slit that extends in one direction. The slit illuminating unit 3, for instance, may be configured by arranging a plurality of optical fibers with end faces lined up side by side in a thin, long rectangular area of the slit. Also, although not shown in the Figs., the outgoing beam exit is provided with a liquid crystal scattering plate similar to the liquid crystal scaling plate 11B.

Its position and attitude are controlled by a slit illuminating control unit 43; it is supported by a moving mechanism, not shown in the Figs., and it can irradiate slit-shaped illuminating light at an appropriate angle at an appropriate position on the wafer 13. The extent of scatting of slit illumination can be varied by the slit illuminating control unit 43.

The spot illuminating unit 4 is an illumining mechanism that converts the light led by the optical fiber 15 through the illuminating light adjusting unit 5 to illuminating light in the form of a spot of light beam of specific diameter on the wafer 13. The spot illuminating unit 4 may comprise of optical elements such as a lens that concentrates diffused light emitted from the optical fiber 15. Also, although not shown in the Figs., the outgoing beam exit is provided with a liquid crystal scattering plate similar to the liquid crystal scattering plate 11B.

Position and attitude of the spot illuminating unit 4 are controlled by a spot illuminating control unit 44. The spot illuminating unit 4 is supported by a moving mechanism, not shown in the Figs., and it can irradiate spot-shaped illuminating light at an appropriate angle at an appropriate position on the wafer 13. The extent of scattering of spot illumination can be varied by the spot illuminating control unit 44.

Thus, visual inspection apparatus 1 includes the illuminating unit, which comprises the light source 8, the illuminating light adjusting unit 5, the optical fibers 14, 15, and a plurality of illuminating mechanisms including wide range illuminating unit 2, slit illuminating unit 3, and spot illuminating unit 4, and which illuminates the test object.

The control unit 9 performs overall control of the visual inspection apparatus 1. As shown in FIG. 2, it generally comprises a control unit 35, a memory 36, a storage unit 37, an input/output control unit 38, and an external control unit 39 (control unit).

The control unit 35 exchanges data such as control signals, inspection condition setting values and setting information of inspection processes summarized by type of inspection process, and defect information between the input/output control unit 38 and the external control unit 39, according to the control program loaded in memory 36. A plurality of data sets is stored properly as files in the storage unit 37 comprising storage media such as hard disks, for instance, and such data can be read from the storage unit 37, if necessary.

In this way, the storage unit 37 serves as a storage unit for storing a plurality of inspection condition setting values and setting information of inspection processes, as well as a defect information storage unit for storing defect information.

Also, the control unit 35 comprises a setting information selection unit that sets the inspection condition setting values for external control unit 39 after selecting the setting information of inspection processes.

The control unit 35 can properly analyze the data stored in the storage unit 37, and can display the results in the monitoring unit 10, by loading an appropriate analysis program in memory 36. In this case, the control unit 35 and the monitoring unit 10 form the analysis and display unit

The input/output control unit 38 is electrically connected to the monitoring unit 10 that forms the input screen for input of inspection condition setting values (hereinafter called “setting input screen”) and displays the defect information and analysis results of defect information. The control unit 38 is also electrically connected to the keyboard 16 for input of inspection condition setting values and so on, and the mouse 17 for selective input of inspection condition setting values by operating the setting input screen. The input/output control unit 38 is a device that converts the input signals of these devices to internal data and sends it to the control unit 35.

Here, the inspection condition setting values refer to the selection information for selecting mans used for performing visual inspection by the visual inspection apparatus selectively, such as selecting the wide range illuminating unit 2, the slit illuminating unit 3, the spot illuminating unit 4, and so on, and for selecting the operating modes of all mechanism including these, or control information and numerical information for setting the operations of these mechanisms. These values may be displayed numerically, or may be input by characters, symbols, and mouse clicks.

The external cool unit 39 is electrically connected to the swinging mechanism drive control unit 40, which is a drive control unit installed outside the control unit 9, the illuminating light adjusting control unit 41, the light source drive unit 42, the slit illuminating control unit 43, the spot illuminating control unit 44, and the wide range illuminating light control unit 45. A plurality of inspection condition setting values input from the input/output control unit 38 and collected as setting information of inspection processes corresponding to inspection processes by the control unit 35, can be sent as control signals corresponding to the relevant external drive control units.

The setting information of inspection processes is assigned a name to distinguish it from other information, and is a data aggregate stored in the storage unit 37 appropriate units such as files. The setting information of inspection processes is abbreviated as “recipe” hereafter.

Next, the operation of the visual inspection apparatus 1 of the present embodiment will be described here.

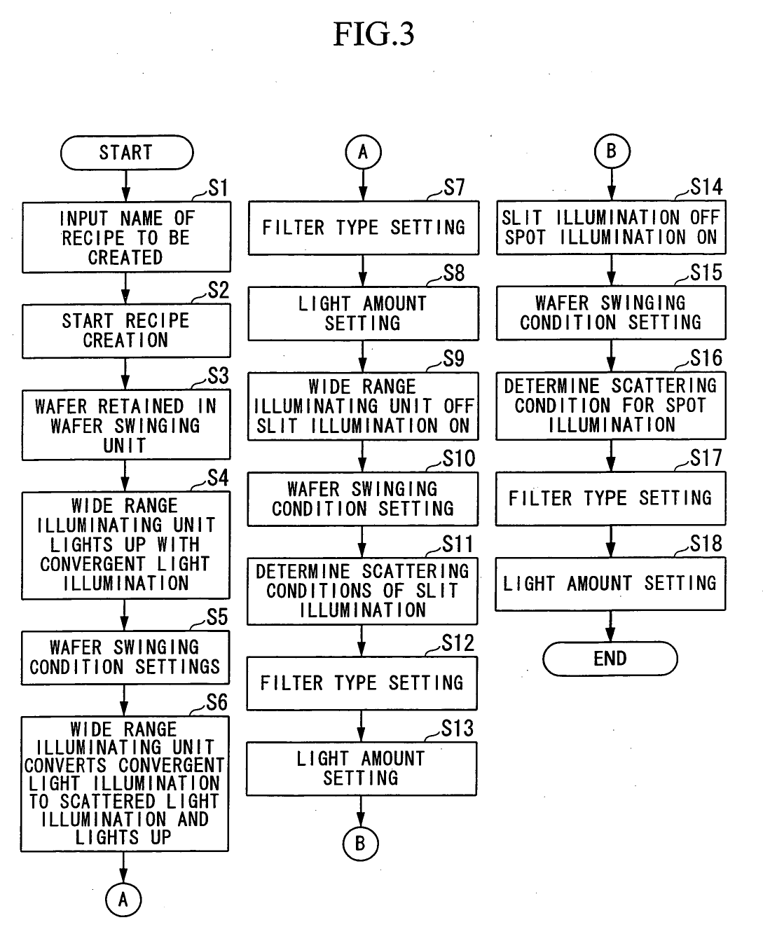

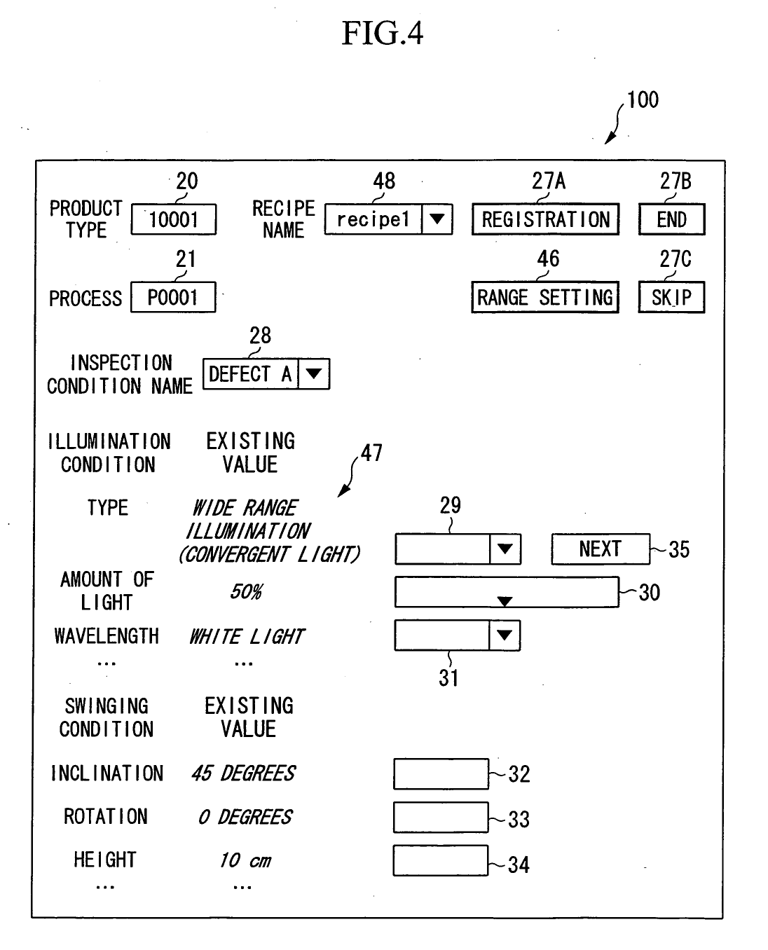

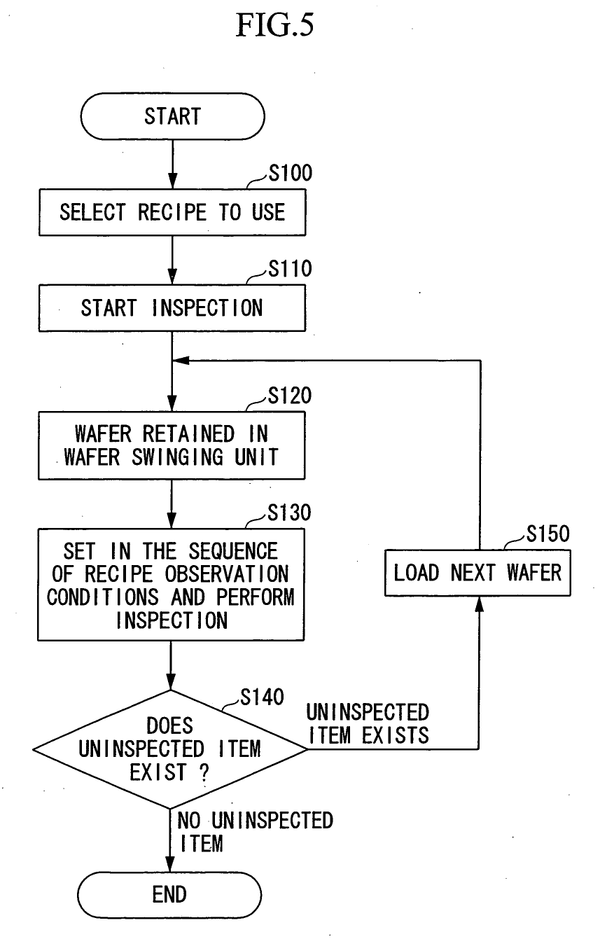

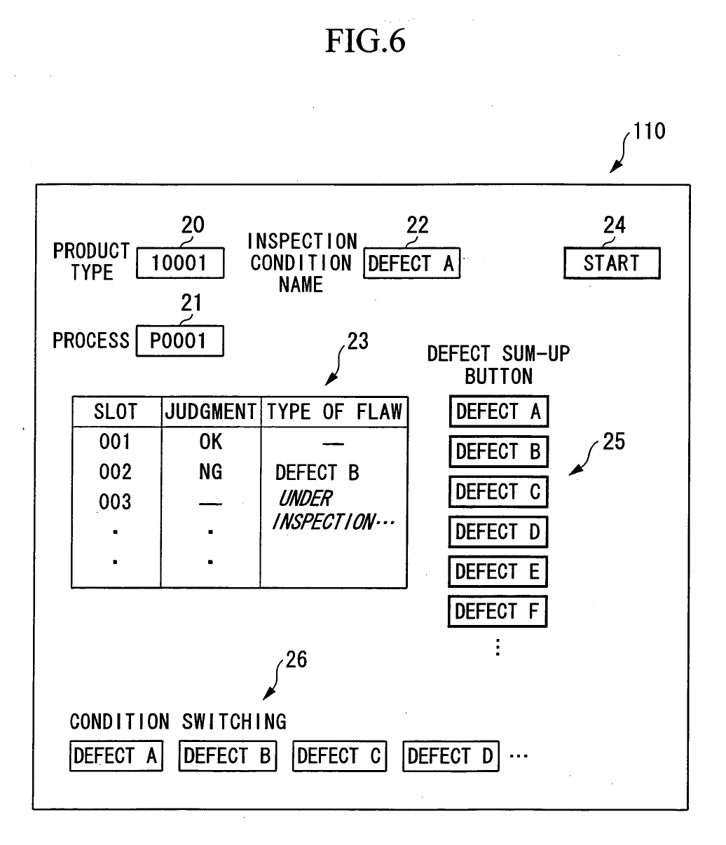

FIG. 3 shows the flow chart for explaining the operation for creating recipe of the visual inspection apparatus according to the embodiment of the present invention. FIG. 4 is an explanatory sketch for explaining an example of the operation screen when creating a recipe of the visual inspection apparatus according to the embodiment of the present invention. FIG. 5 shows the flow chart for explaining the operation of the visual inspection apparatus according to the embodiment of the present invention. FIG. 6 is an explanatory sketch for explaining an example of the operation screen during inspection of the visual inspection apparatus according to the embodiment of the present invention.

When power is switched on, the control unit 35 is initialized, and the control program for performing visual inspection is loaded and automatically run in the visual inspection apparatus. The selection menu type of menu screen (not shown in the Figs.) is displayed in the monitoring unit 10, and menus can be selected by input from keyboard 16, mouse 17, and so on.

The selections of menu screen include the “Recipe Creation Mode” that creates recipes according to the product type of wafer 13, the type of process, and the type of defect to be inspected; the “Recipe Display & Edit Mode” that can create a new recipe after recalling an already created recipe from the storage unit 37, checking the content and editing it; the “Inspection Mode” that stores defect information in the storage unit 37 after visual inspection; and the “Results Display & Analysis Mode” that displays and analyzes the defect information stored in the storage unit 37.

Here, product type of wafer 13 is the type based on the circuit pattern made on the wafer or the difference in diameter of wafer. The type of process of wafer 13 is the type based on the difference in the production process stage of the same product type. The recipe may be created corresponding to one inspection process when only one defect type is to be inspected for the same product type and the same process, or it may be created corresponding to one of a plurality of inspection processes for sequential inspection of a plurality of defect types for the same product type and the same process. In this case, either a plurality of inspection processes can be automatically implemented, or each inspection process can be selectively implemented from a plurality of inspection processes.

Recipes including the case of a plurality of inspection processes will be described below.

If you select the Recipe Creation Mode, the operon indicated in FIG. 3 is performed.

The Recipe Creation Mode in the present embodiment is a mode assists in creating recipes while performing inspection trials for finding out appropriate inspection condition setting values. If you select the Recipe Creation Mode, the program that assists in creating recipes and stored in the storage unit 37 is launched.

In step S1, enter the name of the recipe to be created based on the specified convention, using a keyboard and so on. Let us assume that you entered “recipe1.” This name distinguishes the recipe from other recipes, and is also used in file names stored in the storage unit 37.

In Step S2, the screen of monitoring unit 10 changes over to operation screen 100, as shown in FIG. 4. The operation screen 100 comprises a GUI screen with a plurality of operation input units. In this screen, the necessary operation input units are configured in the input-enabled condition according to the steps below. If the order of settings is relevant, setting values entered subsequently are locked.

A recipe name display input unit 48 displays the recipe name entered in step S1.

Although not shown in the Figs., if the entered recipe name matches the name stored in the storage unit 37, a waning is given indicating the existence of recipe with the same name, and a query screen is displayed for re-entering the data or creating a new recipe based on the existing recipe. For instance, if data is to be re-entered because of an input error, and if you select re-entry, then the recipe name display input unit 48 becomes ready to receive input. You can move to step S3 after changing over to an appropriate name.

On the other hand, you can recall an existing recipe in the Recipe Creation Mode in the visual inspection apparatus 1. That is, if you select creation of a new recipe based on an existing recipe in response to the query, you can proceed to the next step. This operation is described later, explanations on creating a new recipe are given here.

In step S3, the wafer 13 is mounted on the swinging mechanism 12 using a robot aim and the like, not shown in the Figs. At this stage, the inspector enters the names in a product type display unit 20 and a process display unit 21. For instance, assume that 10001 and P0001 are entered in the units using the keyboard 16.

If, however, these names are automatically read by a system such as an automatic conveyor system for wafer 13, the names may be automatically entered from such a system.

Here, the wafer 13 used for creating the recipe, is a wafer in which a defect has been found, and the type of defect has been determined beforehand. The wafer 13 should preferably include a plurality of defects. Moreover, defects may be intentionally introduced in the wafer 13, if necessary.

The mouse 17 may be used to operate inspection condition selection input unit 29 from the pull-down menu, and to select the name of the defect type. For instance, let us select “Defect A” This name is used when registering a recipe when the preferred inspection condition has been decided.

Types of defects include basic defects such as dirt, scratch, foreign matter adhesion, element defect, film unevenness, abnormal edge cut, chipped edge, foreign matter adhering to edge, or if necessary, these may be further subdivided into categories such as shape, size and cause of formation.

When the data above has been entered, input to the illumination type selection unit 29 becomes enabled, and you can proceed to step S4.

In step 4, the type of illumination for creating recipes is automatically selected by the recipe creation support program. If necessary, the type of illumination can also be selected from the illumination type selection unit 29. The illumination type selection unit 29 consists of a pull-down menu, and it may be operated using the mouse 17 and so on.

In the present embodiment, firstly, the mode in which convergent light illumination, that is, convergent light directed to the wafer 13 from the wide range illuminating unit 2, is selected. The control unit 35 recalls the default values of illumination conditions during the convergent light illumination mode from the storage unit 37 and sends them to the external control unit 39.

The external control unit 39 sends the control signal to the light source drive unit 42, the illuminating light adjusting control unit 41, and the wide range illuminating light control unit 45 in response to the received default values, and performs the operation based on the default settings.

For instance, the positions of the adjusting light wheel 7 and filter wheel 6 of the illumining light adjusting unit 5 are rotate so that the light source 8 lights up and the illuminating light becomes white light of a specific volume (for instance, 50% of full output). The liquid crystal scattering plate 11B is made transparent by applying voltage. The relative positions of the outgoing beam exit 2a and the Fresnel lens 11A are adjusted, and the convergent light is irradiated on a specific range of the wafer 13, for instance the entire surface of the wafer. Here, scattered light from mainly foreign matter and scratches is observed.

When deciding the swinging conditions, the default value of the filter is set at “no filter” so as to avoid the possibility of poor visibility because of the effects of the filter. For the same reason, it is preferable to use a filter with an adequately wide half-width as the default value when a bandpass filter is use

These inspection condition setting values set as default values, are displayed in the default value display unit 47 of the operation screen 100, as shown in FIG. 4. Only a part of the display and input interface is schematically shown in the figure for the sake of simplification.

The illumination type selection unit 29, a light amount adjusting unit 30, and a waveform input unit 31 are provided for changing the setting values to values near the default values. Appropriate input methods can be used if necessary, for these. For instance, the waveform input unit 31 can be selected from a pull-down menu, while input to the light amount adjusting unit 30 is through the sliding bar. Other methods may be numerical input in empty columns, or the use of well-known GUI for selection of items through radio buttons. If you select the type using the illumination type selection unit 29, you move to the step corresponding to the illumination selected and described later.

If such convergent light is irradiated on the wafer 13, the illuminating light is deflected because the surge of wafer 13 is generally a smooth reflecting surface. That is, reflected light is concentrated substantially at one point in space.

On the other hand, defects that diffuse light exist on wafer 13, such as dirt, scratch, foreign matter adhesion, or element defect, and a part of the illuming light scatters and arrives at a position displaced from the point of convergence. If wafer 13 is observed at such a position, an effect similar to dark field illumination is obtained. While the reflected light from the wafer 13 cannot be observed, scattered light originating from such defects can be observed. Therefore, defects can be detected by visual inspection.

In step S5, the position and attitude of the swinging mechanism 12 is moved and the optimum setting values studied so as to find the inspector's position that allows the best observation of scattered light originating from defects to be performed.

The position of the swinging mechanism 12 is set at the initial value the moment the power is switched on, and is displayed as the default value in the default value display unit 47 on the operation screen 100 shown in FIG. 4. In this embodiment, conditions are displayed such as inclination from a specific axis—45 degrees; rotating position of the swinging mechanism 12 within supporting plane—0 degrees; and distance of neutral position of wafer 13 from the reference position—10 cm.

To vary the position and attitude of the swinging mechanism 12, the cursor of mouse 17 is moved to inclination input unit 32, rotation input unit 33, height input unit 34, and so on, the arrow keys and mouse wheel, and so on are operated, and the setting values are scrolled. Upon detecting these input values, the control unit 35 sends the data to the external control unit 39. The external control unit 39 converts this data to control signals and sends them to the swinging mechanism drive control unit 40.

Similarly, the input for operation is processed by the control unit 35 and data transferred to the external control unit 39; for the sake of simplification, the explanation of this process is not repeated here.

The swinging mechanism drive control unit 40 drives the movable stage and the rotating stage based on these control signals. The position and attitude of the swinging mechanism 12 is changed and conditions that enable the defect to be viewed clearly are studied. When the optimum conditions are found, they are registered using registration button 27A, and NEXT button 35 is pressed to move to step S6.

This operation may also be performed by using a joystick, operation lever, operation knob, or other inspection condition input units. Also, if the next input operation is not performed even after a fixed period has elapsed after pressing the registration button 27A although the NEXT button 35 has not been pressed, a move may be made automatically to the next illumination type by the recipe creation support program.

In step S6, the wide range illuminating unit 2 is changed over from convergent light illumination to scattered light illumination to inspect unevenness in film thickness (hereafter referred to as “film unevenness”). The input interface for varying the scattering condition, not shown in the Figs., is operated, and the scattering condition setting values are entered. Control signals are sent from the wide range illuminating light control unit 45 to the liquid crystal scattering plate 11B. The extent of scattering of liquid crystal scattering plate 11B is varied, and it is used as a scattering plate. Usually, the voltage applied on the liquid crystal scattering plate is cut off to make the plate a scattering plate. The operation proceeds to step S7.

In step S7, the types of filter for acquiring better inspection conditions of film unevenness are studied. That is, the waveform input unit 31 is operated, control signals are sent to the illuminating light adjusting control unit 41, the optical filter 6b comprising wavelength selection filters is changed over by filter wheel 6, and conditions that enable film unevenness defect to be viewed best are studied. In addition to the method of operating the waveform input unit 31, the filter may be automatically switched over at fixed periods.

When the optimum conditions are found, they are registered by the registration button 27A, and a move is made to step S8.

In step S8, the amount of scattered light required for obtaining better inspection conditions is studied. That is, the sliding bar of the light amount adjusting unit 30 is operated using the mouse 17, and the setting value for the light amount is changed.

As a result, control signal corresponding to the setting value is sent from the external control unit 39 to the illuminating light adjusting control unit 41, the adjusting light wheel 7 is driven and the transmittance is controlled. The light amount is then changed and the conditions for better viewing the film unevenness defect are studied. When optimum conditions are found, they are registered by pressing the registration button 27A using the mouse 17.

The inspection condition sewing values set in steps S4 to S8 are registered for foreign matter and film unevenness defects, and recipe stored as data aggregate in the storage unit 37. For instance, a recipe part with Defect A in the product type 10001 and process P0001 and stored as a data file assigned with appropriate name, can be recalled by the control unit 35.

By pressing the NEXT button 35 to construct the recipe part of the next illumination type, you can move to step S9.

In step S9, the type of defect to be inspected is selected by the inspection condition selection input unit 28. The recipe creation support program selects the slit illumination mode. As a result, the external control unit 39 sends the control signal to the illuminating light adjusting control unit 41, and the destination of the guided outgoing beam of the illuminating light adjusting unit 5 is changed over from the wide range illuminating unit 2 to the slit illuminating unit 3. That is, the wide range illuminating unit 2 is switched off and slit illumination is switched on.

Inspection by slit illumination is meant to detect defects such as dirt, scratches and foreign matter adhesion by gently moving the light in slit shape over the wafer 12 and radiating it from a slanted direction with respect to the wafer 13. In this case too, light scaling occurs due to these defects, therefore, when looking from a direction other than the direction of advance of the regular reflected light from wafer 13, only scattered light is observed, and thus the position of the defect can be detected. To irradiate the slit illumination on a narrow range, the amount of light per unit area can be increased; therefore, smaller defects difficult to observe in wide range illuminating light can be detected.

In steps S10 to S13, similar to steps S5 to S8, the scattering conditions of slit illuminating light, type of filter, and the amount of light are changed to sequentially study conditions for best observing the defects. If the optimum condition is found, the registration button 27A is pressed each time, and the recipe is registered before moving onto step S14.

In step S14, the type of defect to be inspected is selected by the inspection condition selection input unit 28, and the mode changed over to spot illuminating mode by the NEXT button 35 of the illumination type selection unit. As a result, the external control unit 39 sends the control signal to the illuminating light adjusting control unit 41, and the destination of the guided outgoing beam of the illuminating light adjusting unit 5 is changed over from the slit illumining unit 3 to the spot illuminating unit 4. That is, the slit illumination is switched off and spot illumination is switched on

Inspection by spot illumination is performed by brightly illuminating a part of the wafer 13 by spot-shaped light. For instance, it is preferable to irradiate light on the periphery of the wafer 13 and rotate it, for inspecting defects especially on the periphery of wafer 13. Defects such as abnormal edge cut, chipped edge, and foreign maker adhesion to edge can be detected.

In steps S15 to S18, similar to steps S5 to S8, the swinging position, the scattering conditions of spot illuminating light, type of filter, and the amount of light are changed to sequentially study conditions for best observing the defects. When the ideal conditions are found, they are registered as recipe by pressing the registration button 27A. When wafer 13 is not to be inspected, the recipe preparation mode is terminated by pressing end button 27B. That is, the position of wafer 13 is returned to its initial status, wafer 13 is removed from the visual inspection apparatus 1, and the inspection enters the wait state. The screen of the monitoring unit 10 is switched over to the menu screen, not shown in the Figs.

In this way, new recipes with optimized inspection condition setting values for each illumination type and each defect type can be created while implementing processes conforming to macro inspections.

In the explanations above, an example of setting one optimum value for each of the inspection condition setting values was given, but considering the variation of the test object, a range around the optimum value may be assigned, and during actual inspection, recipes may be created to implement a plurality of inspection processes by varying the inspection condition setting values within this range. In such a case, after entering the optimum value, range setting button 46 is pressed. Tee screen for setting the range appears, and entries such as the upper and lower limits of the range and step width for varying values within the range can be made on this screen.

The swinging condition is one example of an effective inspection condition setting value for such a range setting.

Also, in the Recipe Creation Mode, an existing recipe name is entered in step S2, and in response to the query, the creation of a new recipe can also be selected based on an existing recipe. In this case, the new recipe name is entered since an additional screen for entry of new recipe name is displayed. Steps thereafter may be followed in almost a similar manner, but the aforementioned existing values are not default values, and the points set in the inspection condition setting values of existing recipes recalled first are different.

Thereafter, the setting values can be changed while performing the actual inspection based on these values, and then entered as new inspection condition setting values.

Particularly, the inspection condition setting values of the existing recipe can also be used as-is. In this case, by pressing skip button 27C, the inspection at the set values can be omitted, and you can jump to the step for setting the next inspection condition setting values.

If the end button 27B is pressed, the new recipe will be register in the storage unit 37.

Next, the Recipe Display & Edit mode will be described hereinafter.

When the Recipe Display and Edit Mode is selected from the operation screen (not shown in the Figs.), the screen changes to the operation screen 100 in the monitoring unit 10) similar to that of the Recipe Creation Mode shown in FIG. 4. The point in which it differs from the Recipe Creation Mode is that editing can be performed online with the display and edited results not being reflected immediately in the operation of the visual inspection apparatus 1. Accordingly, the content of the existing recipes can be confirmed and items editable for the period until the inspection is tried out, can be edited or copied.

Next, the operation of Inspection Mode for performing inspections using already-created recipe will be described hereinafter.

The Inspection Mode of the present emit is a mode for determining whether the test object is good or bad by sequentially the test object using the recipes stored in the storage unit 37. All the defect data can be stored, and can be used in the learning function mentioned later.

If the Inspection Mode is selected from the operation screen (not shown in the Figs.), operations as shown in FIG. 5 can be performed.

In step S100, recipe to be used in the inspection can be selected from the operation screen, not shown in the Figs.

In step S110, operation screen 110 is displayed, as shown in the monitoring unit 10 of FIG. 6. Inspection starts when the inspection start button 24 is pressed.

The operation screen includes the product type name of wafer 13, which is the test object; the product type display unit 20 that displays the process names; the process display unit 21; the inspection condition display unit 22 that displays the inspection condition names corresponding to the type of defects; the results display unit 23 that displays the defect information, and so on.

It also includes input units such as a condition switch button 26 for switching to manual input of the inspection conditions, and defect gum-up button 25 for sing up the number of defects according to type.

In step S120, the wafer 13 is retained in the swinging mechanism 12 using a robot arm and the like, not shown in the Figs. At this stage, the wafer 13 accommodated in a specific slot is removed from the cassette conveyed by the automatic conveyance system. The product type name and process name of wafer 13 corresponding to this slot number are read and this data is automatically input to the visual inspection apparatus 1. They are then displayed in the product type display unit 20 and the process display unit 21.

In step S130, inspection is carried out according to the inspection process based on the recipe. At this stage, inspections will be carried out for each defect type in the specified sequence since the inspection condition setting values corresponding to the defect type set in the recipe creation mode have been stored in the recipe. For instance, inspection will be carried out sequentially through Defect A, Defect B, . . . and so on.

In step S140, the inspector judges the type of defect (if any), and inputs the type from the defect sum-up button 25. At this stage, even if defects other than the inspection condition names are detected, they are all input by pressing the relevant defect sum-up button 25. The data of all these defects are stored in the storage unit 37. That is, the storage unit 37 is also used as a defect information storage unit; the correspondence between the inspection condition setting values and the detected defects can be stored in this unit.

After judging the existence of un-inspected items, and if none exist, the inspection mode terminates. If an un-inspected item exists, the process moves to step S150.

In step S150, the un-inspected wafer 13 is loaded, and steps S120 to S140 are repeated.

For instance, in the example displayed in the results display unit 23, the wafer 13 of slot number 001 is judged as satisfactory and free of all defects. The wafer 13 in slot number 002 has been judged as a defective item, based on the inspection conditions of Defect B. Currently, inspection conditions of Defect A are being applied to the wafer 13 in slot number 003.

The example of sequential inspection by defect types by automatically switching over the setting information of a plurality of inspection processes stored in recipes was described above. In this case, setting information of a plurality of inspection processes is selected sequentially in the order in it has been stored in the recipes by the control unit 35, which is the setting information selection unit. On the other hand, if the inspector presses the condition switch button 26 of FIG. 6 to input data, manual settings can be performed and the inspection process information corresponding to the condition switching button 26 can be selected for control unit 35.

Next, the Results Display & Analysis Mode will be described hereinafter.

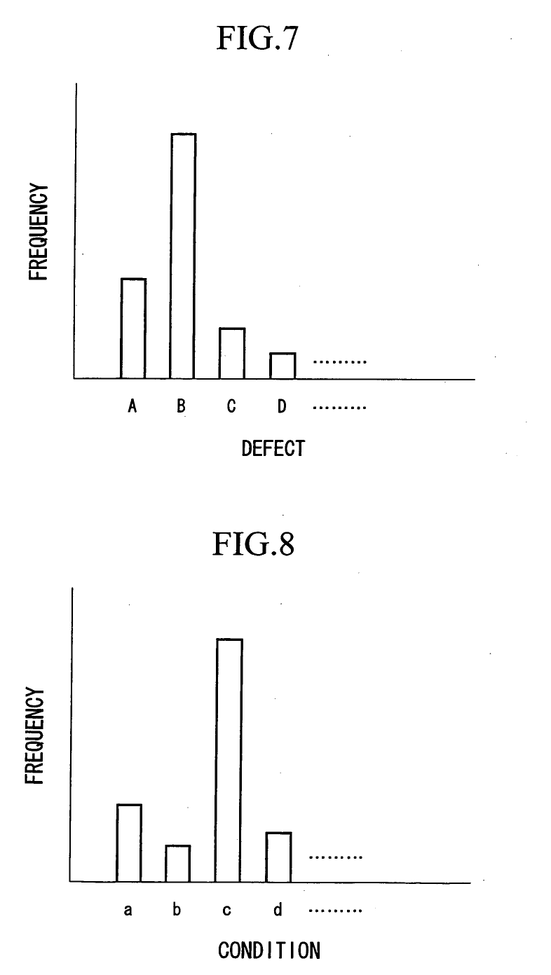

FIG. 7 and FIG. 8 show graphs indicating examples of executing the Results Display & Analysis Mode by the visual inspection apparatus according to the embodiment of the present invention. The horizontal axes in the graphs indicate the type of defect and inspection conditions respectively, while the vertical axes indicate the frequency.

The visual inspection apparatus 1 includes a recipe creation support function and a recipe learning function that analyzes the defect information stored in the storage unit 37. This Results Display & Analysis Mode can be switched over during an operation to the aforementioned inspection mode. If necessary, the recipe can be changed.

When the Results Display & Analysis Mode is selected, the analysis program is loaded in memory 36, and the control unit 35 performs the analysis. The analyzed results can be displayed as graphs or tables in the monitoring unit 10.

Statistical analysis of data of defect information stored in the storage unit 37 can be given as examples of analysis.

For instance, the graph in FIG. 7 is a histogram showing the frequency of each type of defect that was actually detected during inspection with a recipe created for a type of defect, namely Defect B. In this example, the frequency of detection of Defect B is the highest, but the frequency of detection of Defect A is also about half that of Defect B. Accordingly, the inspector can understand that this recipe has been set with conditions that relatively facilitate detection of Defect A. Therefore, the recipe can be modified, if necessary. Moreover, expertise can be obtained such as becoming aware that inspection may be performed paying attention to Defect A also when using this recipe.

If a graph as shown in FIG. 7 is displayed in the recipe for detecting Defect A, then it can be seen that it is inappropriate for Defect A. In this case, the type of defect of this recipe may be changed to Defect B. Such analysis may be performed periodically, and management of the recipes may be performed, such as for instance, an existing recipe can be retained as recipe that inspects defect types only if its defect detection frequency is highest, or it can be changed.

The graph shown in FIG. 8 is a histogram indicating a specific defect type, for instance, the frequency of Defect A detected per recipe. In the example shown, the frequency of detection in the ripe is highest for condition c. The relationship between the recipe and the type of defect detected can be verified from this graph.

The inspector can see the graph of analyzed results such as this graph, can qualitatively and quantitatively understand the effectiveness of the recipe with ease, and even an inspector with little experience can improve the accuracy of recipe preparation. Histogram display is one example of displaying analyzed results; other display methods may also be adopted. For instance, graphs adapted to scatter diagrams or curves indicating correlation, or other appropriate graph displays can be used. Also, typical statistical values such as averages and dispersion may be indicated by numeric tables.

Analysis for finding the optimum inspection condition setting value using statistical analysis methods such as multivariate analysis can be used as an example of other kinds of analysis.

If the recipe creation mode is used, a trial recipe is created to decide the inspection condition setting values, defect information is collect and analysis of the optimum values of the inspection condition setting values is performed by the Results Display & Analysis mode, then the recipe can also be automatically created experimentally.

As mentioned above, according to the visual inspection apparatus 1 of the preset embodiment, recipe can be created while performing inspection in the recipe creation mode, this recipe can be stored, and can be used for visual inspection. Accordingly, even an inspector with little experience can perform visual inspection efficiently and speedily. By sharing and using already created recipes, inspection condition setting values can be set correctly and accurately when similar inspection processes are repeated.

Also, by the Recipe Display & Edit mode, and the Results Display & Analysis Mode, these recipes can be transferred to create other recipes and can be improved, thus, recipes can be created efficiently.

The explanations above are for convergent light assumed as the type of illumination of the wide range illuminating unit 2, but naturally, even parallel light may be used for the illumination. Parallel light can be used to detect dirt, scratches, foreign matter adhesion, missing elements, and so on similar to convergent light. Particularly, parallel light has the advantage that it can illuminate a wide range even on large objects compared to convergent light.

It has been explained that the test object is to be inspected by direct observation through naked eyes during macro inspection, but displaying the test object in a monitor through an imaging device and inspecting it visually may also be included as part of visual macro inspection. Other images may be compared, based on images displayed on the monitor, to automatically detect defects and categorize faults.

In the aforementioned explanations, examples that included setting values for illumination condition and swinging condition were described, but depending on the inspection, only one of the two kinds of setting values may be used. If other inspection means exists, then the inspection condition setting values may be included.

Also, in the aforementioned explanations, a plurality of inspectors existed, all inspectors analyzed the statistical data, and the recipe was changed to an optimum one. However, individual names may be input so that statistical data by each individual is taken, and recipe may be changed to optimum recipe of each individual.

As described above in the embodiment of the present invention, the visual inspection apparatus of the present invention should preferably comprise a setting condition input unit for input of inspection condition setting values for performing the inspection processes, and a setting information selection unit that stores the inspection condition setting values input by the sexing condition input unit as setting information of inspection processes in the storage unit, selects the setting information of inspection processes from the stored setting information of inspection processes, and sets the inspection condition setting values for the control unit.

In this case, inspection condition setting values are input for implementing the inspection process by the setting condition input unit. These inspection condition setting values are stored in the storage unit as setting information of inspection processes for each inspection process, wherefrom the setting information of inspection processes is selected by the setting information selection unit, and the inspection condition setting values of this setting information of inspection processes can be set for the control unit. For this reason, when the setting information of inspection processes is stored once, all the inspection condition setting values can be read when necessary by merely selecting the setting information of inspection processes from the next time, thereby facilitating the setting of inspection condition setting values.

Also, in the visual inspection apparatus of the present invention, the illuminating unit should preferably be provided with a plurality of types of illuminating mechanisms, and the setting information of inspection processes should preferably be created when the plurality of types of illuminating mechanisms are automatically selected by a creation support program in the storage unit.

In this case, the setting information of inspection processes is created when the plurality of types of illuminating mechanisms are automatically selected by the creation support program stored in the storage unit; therefore, the setting information of inspection processes corresponding to the type of illuminating mechanism can be created speedily and efficiently.

In the visual inspection apparatus of the present invention, the setting information selection unit should preferably be configured so that it can implement a plurality of inspection processes sequentially based on the setting information of the plurality of inspection processes, by automatically switching over and selecting the setting information of the plurality of inspection processes.

In this case, the efficiency of the inspection can be improved because a plurality of inspection processes are sequentially implemented based on a preset sequence by the setting information selection unit.

Also, overlooking of defects can be prevented by setting the setting information of a plurality of inspection process and automatically switching and implementing them so that the inspection condition setting values are varied in a specific range related to particular inspection conditions.

The visual inspection apparatus of the present invention should preferably comprise the aforementioned setting condition input unit in which the inspection condition setting values during the external inspection are input so that setting information for inspection processes can be updated.

In this case, the improvement or modification of setting information for inspection processes is facilitated because when more preferable inspection condition setting values are found during visual inspection, those conditions can be reflected immediately in the setting information for inspection processes.

The visual inspection apparatus of the present invention should preferably comprise a defect information input unit that enables defect information of the aforementioned visual inspections to be input by the inspection process, and a defect information storage unit that stores defect information input to the defect information input unit after associating it with the setting information for previously implemented inspection processes.

In this case, defect information can be input from the defect information input unit by inspection process, associated with the setting information for inspection processes, and can be stored in the defect information storage unit. Accordingly, data associated with inspection setting conditions and defect information can be accumulated, and this data can be recalled when necessary.

Among the visual inspection devices of the present invention, a device comprising the aforementioned defect information input unit and the aforementioned defect information storage unit should preferably further comprise an analysis and display unit that analyzes and displays the relationship between the defect information stored in the aforementioned defect information storage unit and the aforementioned setting information for inspection processes.

In this case, the effectiveness of the setting information for inspection processes can be easily determined because the relationship between the defect information and the setting information for inspection processes that have been implemented can be analyzed by the analysis and display unit. That is, a device provided with support functions for setting information of inspection processes can be realized.

The analyses of the analysis and display unit may include for instance, statistical processing or statistical analysis of detected defect types and inspection condition setting values. That is, histograms of frequencies of each defect type detected in particular inspection conditions, histograms of frequencies of each inspection condition type that have detected particular defect types, and the averages and standard deviations of inspection condition setting values of particular inspection conditions that have detected particular defects may be offered as the results of analyses.

Moreover, among the visual inspection devices of the present invention, a device comprising the aforementioned defect information input unit and the aforementioned defect information storage unit, or a device comprising the aforementioned defect information input unit, the aforementioned defect information storage unit, and the aforementioned analysis and display unit, should preferably be configured such that it can analyze the relationship between the defect information stored in the aforementioned defect information storage unit and the aforementioned setting information for inspection processes, generate new setting information for inspection processes based on these analyzed results, and store this information in the aforementioned storage unit.

In this case, the relationship between the defect information stored in the defect information storage unit and the setting information for inspection processes is analyzed, new setting information for inspection processes is generated based on the analyzed results and stored in the storage unit. For instance, when inspection condition setting values and the detection rate of particular laws are analyzed, the inspection conditions for detective particular defects can be updated to conditions with the highest detection rate from among the inspection condition setting values until then. For this reason, a learning function for inspection can be provided.

While the preferred embodiment of the invention has been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A visual inspection apparatus, comprising:
a swinging unit that movably swings and retains a test object;
an illuminating unit that irradiates illuminating light on the test object for observing images of the test object;
a storage unit that stores the setting information for inspection processes for implementing inspection processes; and
a control unit that automatically controls the illuminating unit and/or the swinging unit based on the setting information for inspection processes.

2. The visual inspection apparatus according to claim 1, further comprising:
a setting condition input unit that inputs inspection condition setting values for implementing the inspection processes; and
a seeing information selection unit that stores the inspection condition se values input by the setting condition input unit as the setting information for inspection processes to the storage unit, selects the setting information for inspection processes from the stored setting information for inspection processes, and sets the inspection condition setting values for the control unit.

3. The visual inspection apparatus according to claim 2, wherein each of the inspection condition setting values has a range around one value.

4. The visual inspection apparatus according to claim 1, wherein:
the illuminating unit includes a plurality of types of illuminating mechanisms; and
the setting information for inspection processes is created by automatic selection of a plurality of types of illuminating mechanisms by a creation support program stored in the storage unit.

5. The visual inspection apparatus according to claim 2, wherein the setting information selection unit implements a plurality of inspection processes sequentially based on the setting information of a plurality of inspection processes by automatically switching over and selecting the setting information of the plurality of inspection processes.

6. The visual inspection apparatus according to claim 5, wherein the setting information selection unit switches a plurality of types of illuminating mechanisms of the illuminating unit at fixed periods.

7. The visual inspection apparatus according to claim 2, wherein the setting condition input unit inputs the inspection condition setting values during the visual inspections, and updates the setting information for inspection processes.

8. The visual inspection apparatus according to claim 1, further comprising:
a defect information input unit that enables input of defect information of visual inspections for each inspection process; and
a defect information storage unit that stores defect information input to the defect information input unit after associating it with the setting information for the implemented inspection processes.

9. The visual ins-eon apparatus according to claim 8, wherein the defect information input to the defect information input unit includes information on the number of defects of each defect type.

10. The visual inspection an according to claim 8, further comprising an analysis and display unit that analyzes and displays the relationship between the defect information stored in the defect information storage unit and the setting information for inspection processes.

11. The visual inspection apparatus according to claim 10, wherein the analysis and display unit displays histograms of frequencies of each defect type.

12. The visual inspection apparatus according to claim 10, wherein the analysis and display unit displays histograms of frequencies for setting information of each inspection process that has detected defects.

13. The visual inspection apparatus according to claim 8, wherein the visual inspection apparatus analyzes the relationship between the defect information stored in the defect information storage unit and the setting information for inspection processes, and generates and stores the new setting information for inspection processes according to the analyzed results in the storage unit.
